(19) United States
(12) Patent Application Publication
(10) Pub. No.: US 2024/0278332 A1
(43) Pub. Date: Aug. 22, 2024

(54) CUTTING INSERT, CUTTING TOOL, AND METHOD FOR MANUFACTURING MACHINED PRODUCT

(71) Applicant: KYOCERA Corporation, Kyoto-shi (JP)

(72) Inventor: Yoshihito IKEDA, Ritto-shi (JP)

(73) Assignee: KYOCERA Corporation, Kyoto-shi (JP)

(21) Appl. No.: 18/652,161

(22) Filed: May 1, 2024

Related U.S. Application Data
(63) Continuation of application No. 17/260,689, filed on Jan. 15, 2021, now Pat. No. 11,992,884.

(30) Foreign Application Priority Data
Jul. 18, 2018 (JP) 2018-134966

(51) Int. Cl. B23B 27/16; B23B 1/00; B23B 27/14

(52) U.S. Cl. CPC B23B 27/1611; B23B 1/00; B23B 27/143

(57) ABSTRACT

A cutting part of a cutting insert may include a first surface including a corner, a first side, a first region, a second region and a third region. The first region may be located along the corner and the first side. The second region may be located at a more inner part than the first region. The third region may be located at a more inner part than the second region. A boundary between the corner and the first side may be a first point. A boundary between the first region and the second region may be a second point in a cross section that passes through the first point and is orthogonal to the first side. An imaginary straight line passing through the first point and the second point may be a first imaginary straight line. The first imaginary straight line may intersect with the third region.

### CROSS-REFERENCE TO RELATED APPLICATIONS

This application is a continuation application of U.S. patent application Ser. No. 17/260,689, filed Jan. 15, 2021, which is a national stage entry according to 35 U.S.C. 371 of PCT Application No. PCT/JP2019/028073, filed on Jul. 17, 2019, which claims priority to Japanese Application No. 2018-134966, filed on Jul. 18, 2018, which are entirely incorporated herein by reference.

### TECHNICAL FIELD

The present embodiments relate to a cutting insert, a cutting tool and a method for manufacturing a machined product.

### BACKGROUND

For example, a cutting tool (cutting insert) described in WO 2015/083716 (Patent Document 1) has been used as a cutting tool used for carrying out a cutting process of a workpiece, such as a high hardness material. The cutting insert described in Patent Document 1 includes a honed surface and a breaker wall surface, and is formed of an ultra-high pressure sintered body including cubic boron nitride or diamond.

Chip disposal may become unstable in a cutting process of a workpiece of a high hardness material, such as hardened steel. This is because a surface of the hardened steel has relatively high hardness but the interior thereof has relatively low hardness. If the cutting process of the workpiece of the high hardness material is carried out using the cutting insert formed of the ultra-high pressure sintered body as described in Patent Document 1, a width of the honed surface (land surface) is set to a large value, or alternatively a honing angle (land angle) is set to a large value in order to enhance durability necessary to cut out the surface of the hardened steel which has the relatively high hardness.

In the case of cutting out the interior of the hardened steel which has the relatively low hardness, chips in unstable state tend to flow along the honed surface. Because the breaker wall surface is low and located away from the cutting edge in the insert described in Patent Document 1, the breaker wall surface may fail to handle the chips.

### SUMMARY

A cutting insert in embodiments includes a base and a cutting part. The cutting part includes a sintered body of cubic boron nitride or diamond and connects to the base. The cutting part includes a first surface, a second surface and a third surface. The second surface is located on a side opposite to the first surface. The third surface is located between the first surface and the second surface. The first surface includes a corner, a first side, a first region, a second region and a third region. The first side is extended from the corner. The first region is located along the corner and the first side and is inclined upward toward an inner part of the first surface. The second region is located along the first region at a more inner part than the first region and is inclined relative to the first region. The third region is located at a more inner part than the second region and is inclined upward. A boundary between the corner and the first side is a first point. A boundary between the first region and the second region is a second point in a cross section which passes through the first point and is orthogonal to the first side in a plan view of the first surface. An imaginary straight line passing through the first point and the second point is a first imaginary straight line. The first imaginary straight line intersects with the third region.

### BRIEF DESCRIPTION OF THE DRAWINGS

FIG. 1 is a perspective view illustrating a cutting insert in non-limiting aspects of the present disclosure;

FIG. 2 is an enlarged view of a region G1 in FIG. 1;

FIG. 3 is a top view of the cutting insert illustrated in FIG. 1;

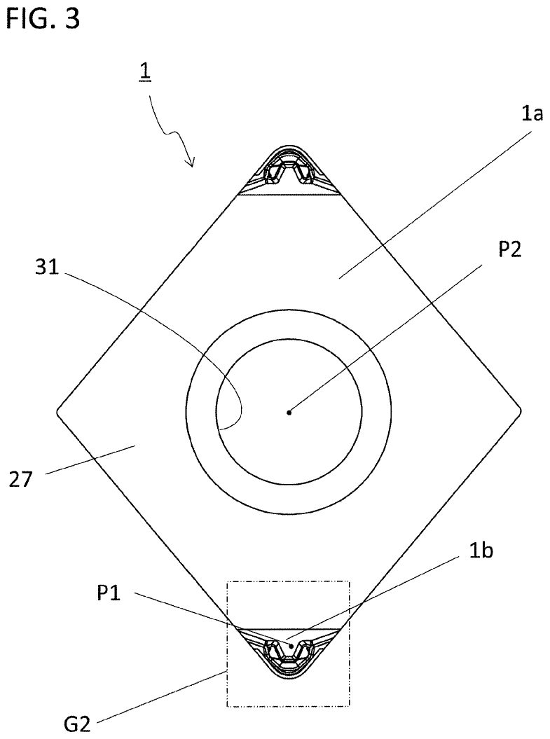

FIG. 4 is an enlarged view of a region G2 in FIG. 3;

FIG. 5 is a cross-sectional view taken along the line V-V in FIG. 4;

FIG. 6 is a cross-sectional view taken along the line VI-VI in FIG. 4;

FIG. 7 is a cross-sectional view illustrating a cutting insert in the non-limiting aspects of the present disclosure;

FIG. 8 is a cross-sectional view taken along the line VIII-VIII in FIG. 4;

FIG. 9 is a cross-sectional view illustrating a cutting insert in the non-limiting aspects of the present disclosure;

FIG. 10 is a cross-sectional view taken along the line X-X in FIG. 4;

FIG. 11 is a cross-sectional view taken along the line XI-XI in FIG. 4;

FIG. 12 is a perspective view illustrating a cutting tool in non-limiting aspects of the present disclosure;

FIG. 13 is a diagram illustrating one of steps in a method for manufacturing a machined product in non-limiting aspects of the present disclosure;

FIG. 14 is a diagram illustrating one of the steps in the method for manufacturing a machined product in the non-limiting aspects of the present disclosure; and

FIG. 15 is a diagram illustrating one of the steps in the method for manufacturing a machined product in the non-limiting aspects of the present disclosure.

### EMBODIMENTS

### Cutting Inserts

The cutting insert 1 (hereinafter also referred to simply as “the insert 1”) in non-limiting embodiments of the present disclosure is described in detail below with reference to the drawings. For convenience of description, the drawings referred to in the following illustrate, in simplified form, only main members necessary for describing the insert 1 in the embodiments. The cutting insert 1 in the present disclosure is therefore capable of including any arbitrary structural member not illustrated in the drawings referred to. Dimensions of the members in each of the drawings faithfully represent neither dimensions of actual structural members nor dimensional ratios of these members.

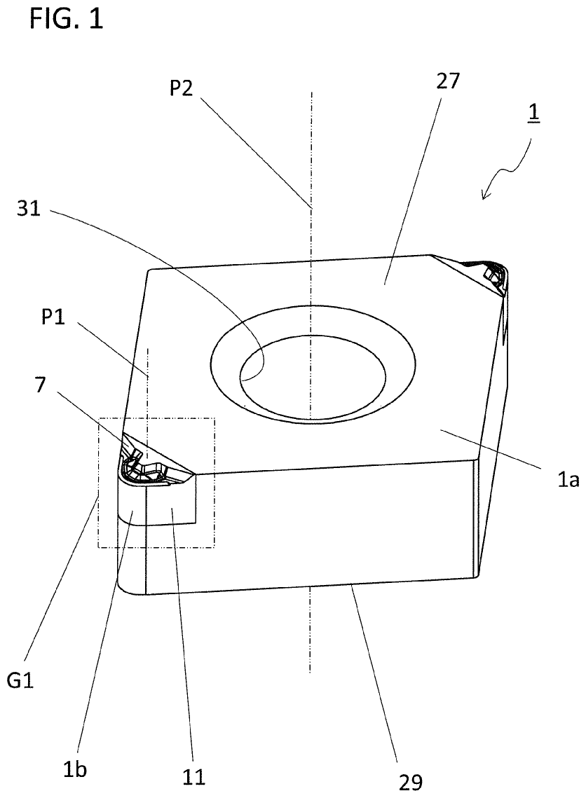

The insert 1 may include a base 1a and a cutting part 1b as in one embodiment illustrated in FIG. 1. The cutting part 1b may connect to the base 1a and may be a sintered body including at least one of cubic boron nitride (cBN) and diamond. In other words, the cutting part 1b may include a sintered body of cubic boron nitride or diamond.

The insert 1 may have a polygonal plate shape as a whole. The insert 1 has an approximately quadrangular plate shape in the embodiment illustrated in FIG. 1. The base 1a may have an approximately polygonal plate shape, and a part of corners may be cut off. The base 1a may have an approximately quadrangular plate shape and a part of the corners may be cut off as in the embodiment illustrated in FIG. 1. The cutting part 1b may connect to the part thus cut off by using, for example, a brazing filler metal. The cutting part 1b may have an approximately triangular plate shape as in the embodiment illustrated in FIG. 1.

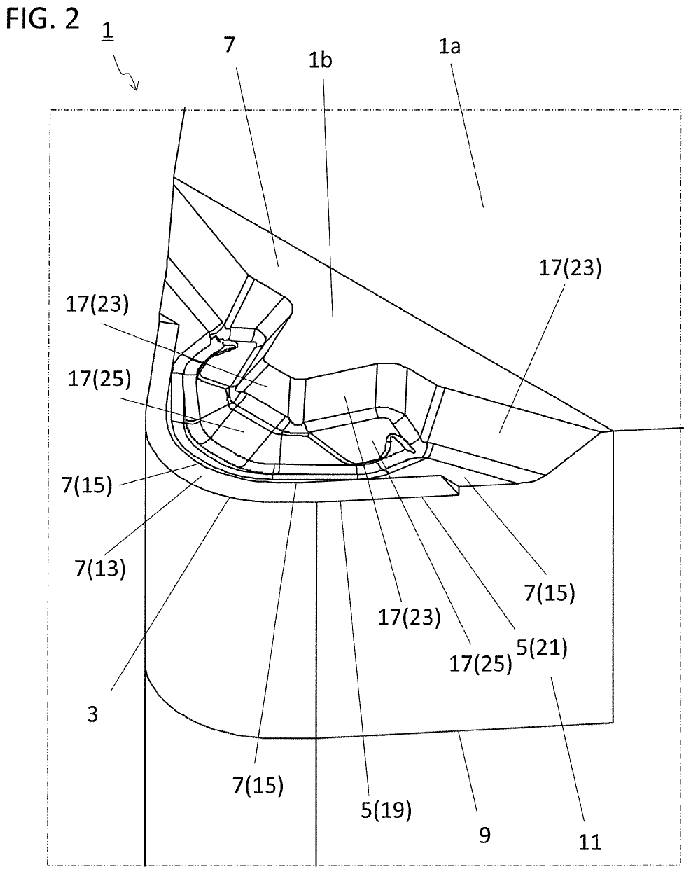

The base 1a and the cutting part 1b are not limited to the above configurations. For example, the base 1a and the cutting part 1b may individually have a quadrangular plate shape and may have the same shape in plan view. The cutting part 1b having the quadrangular plate shape may be located on the base 1a having the quadrangular plate shape. The cutting part 1b may include a first surface 7, a second surface 9 and a third surface 11. The second surface 9 may be located on a side opposite to the first surface 7. The third surface may be located between the first surface 7 and the second surface 9. The first surface 7 may include a first corner 3 and a first side 5 extended from the first corner 3 as in one embodiment illustrated in FIG. 2. A part of the second surface 9 and a part of the third surface 11 in the cutting part 1b may connect to the base 1a as in the embodiment illustrated in FIG. 2. The term “in a plan view” may denote viewing the first surface 7 from front.

The first surface 7 is located above the cutting part 1b in the embodiment illustrated in FIG. 2. Therefore, the first surface 7 may be rephrased as the upper surface 7 for the sake of convenience. The second surface 9 is located below the cutting part 1b in the embodiment illustrated in FIG. 2. Therefore, the second surface 9 may be rephrased as the lower surface 9 for the sake of convenience. The third surface 11 may be located between the upper surface 9 and the lower surface 9 and may connect to these surfaces as in the embodiment illustrated in FIG. 2. The third surface 11 may therefore be rephrased as the lateral surface 11 for the sake of convenience.

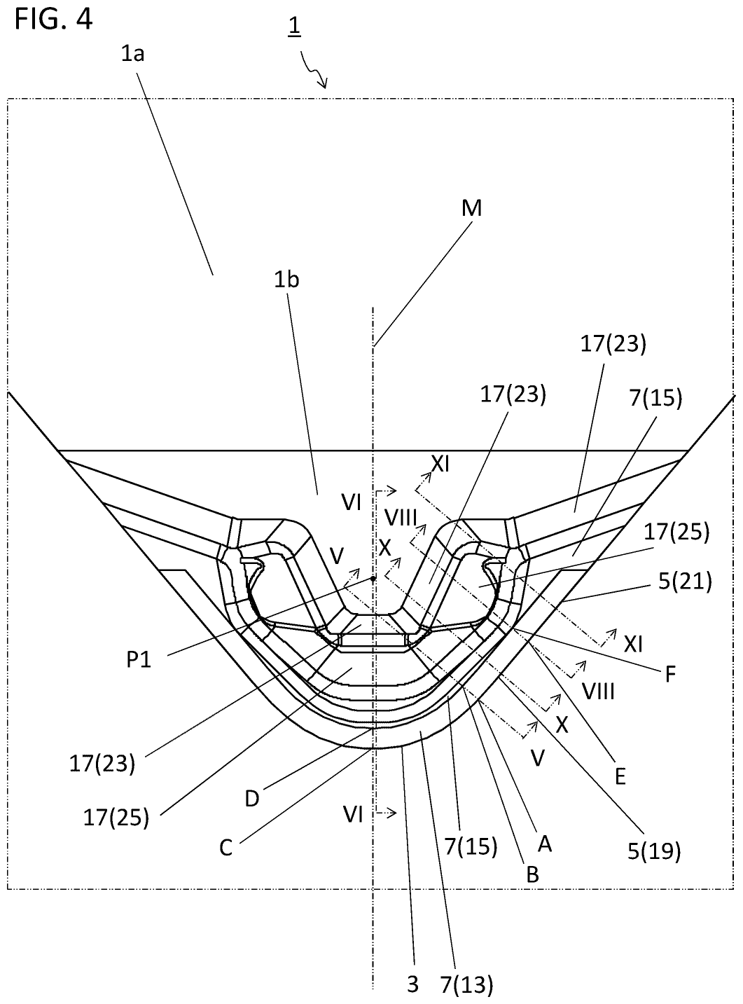

The upper surface 7 has a polygonal shape. The upper surface 7 may have a triangular shape as in one embodiment illustrated in FIG. 4. The upper surface 7 may include three corners and three sides as in the embodiment illustrated in FIG. 4. If the upper surface 7 has the triangular shape, the lateral surface 11 may be made up of three surface regions. The shape of the upper surface 7 is not limited to that in the embodiment illustrated in FIG. 4. For example, there is no problem even if the upper surface 7 has, besides the triangular shape, a quadrangular shape, a pentagonal shape, a hexagonal shape or an octagonal shape.

The first corner 3 is one of three corners of the upper surface 7 in FIG. 4. The first side 5 is one of the three sides of the upper surface 7.

The upper surface 7 may have an approximately polygonal shape and need not have a strict polygonal shape. That is, the sides of the upper surface 7 having the polygonal shape do not need to have a strict straight line shape, but may have, for example, a convex curvilinear shape or concave curvilinear shape. The corners of the upper surface 7 having the polygonal shape are not limited to a structure where two straight lines intersect each other. For example, the corners may have a shape rounded outward.

The first side 5 may have a straight line shape in a plan view of the upper surface 7 as in the embodiment illustrated in FIG. 4. The first corner 3 may have a convex curvilinear shape. Specifically, the first corner 3 may have a circular arc shape whose radius of curvature is constant, or alternatively may be made up of a plurality of portions different in radius of curvature. Hereinafter, the plan view of the upper surface 7 may be rephrased as a top plan view thereof.

Dimensions of the cutting part 1b are not particularly limited. For example, a length of the first side 5 of the upper surface 7 may be set to approximately 0.2-2 mm. A height from the upper surface 7 to the lower surface 9 may be set to approximately 2-8 mm.

The insert 1 may include a cutting edge located on a ridgeline where the upper surface 7 intersects with the lateral surface 11. The cutting edge may be used for cutting out a workpiece. The cutting edge may be located on the whole or a part of the ridgeline. For example, the cutting edge may be located on the first corner 3 of the upper surface 7 and on a part of the first side 5 being continuous with the first corner 3. The cutting edge may be located on the whole of the first corner 3 and in a partial region of the first side 5 which is adjacent to the first corner 3 as in the embodiment illustrated in FIGS. 2 and 4.

The upper surface 7 may include a first region 13, a second region 15 and a third region 17 as illustrated in FIGS. 2 and 4 or the like. The first region 13 may be located along the first corner 3 and the first side 5, and may be inclined upward toward an inner part of the upper surface 7. The first region 13 may be a flat surface or curved surface. If the first region 13 is the flat surface, the first region 13 may be called a chamfer. If the first region 13 is the curved surface, the first region 13 may be called a honed surface.

The second region 15 may be located along the first region 13 at a more inner part than the first region 13, or alternatively may be inclined relative to the first region 13. The third region 17 may be located at a more inner part than the second region 15, or alternatively may be inclined upward. The term “inclined upward” may denote being inclined so as to be located further away from the lower surface 9 (second surface 9) as going toward the inner part of the upper surface 7 (first surface 7).

The second region 15 may be inclined relative to the first region 13 as described above. Specifically, the second region 15 may be located closer to or parallel to the lower surface 9 as going toward the inner part of the upper surface 7. Alternatively, the second region 15 may be located further away from the lower surface 9 as going toward the inner part of the upper surface 7. If the second region 15 is located away from the lower surface 9 as described above, the second region 15 has a more moderate inclination than the first region 13 and the third region 17.

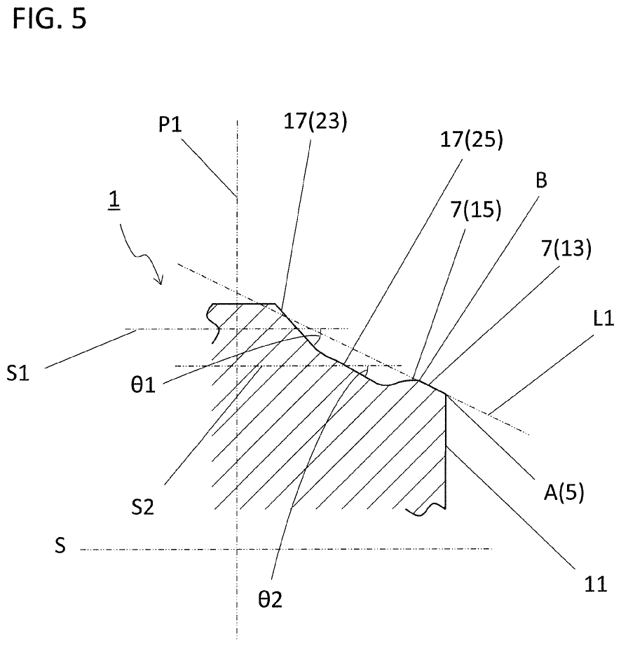

A boundary between the first corner 3 and the first side 5 is a first point A as illustrated in FIG. 2. FIG. 5 illustrates a cross section that passes through the first point A and is orthogonal to the first side 5 in a plan view. A boundary between the first region 13 and the second region 15 is a second point B as illustrated in FIG. 5. The boundary between the first region 13 and the second region 15 is indicated by a line in the plan view, but the boundary is indicated by a point in a sectional view as illustrated in FIG. 5. An imaginary straight line passing though the first point A and the second point B is a first imaginary straight line L1.

An imaginary straight line passing through a center (center of gravity) of the upper surface 7 and a center (center of gravity) of the lower surface 9 is a central axis Pl. An imaginary flat surface orthogonal to the central axis P1 is a reference plane S. FIG. 5 is also a cross section that passes through the first point A and is orthogonal to the first side 5 in a plan view of the reference plane S. The lower surface 9 is parallel to the reference plane S in one embodiment illustrated in FIG. 5. In other words, the term “inclined upward” denotes being inclined so as to be further away from the reference plane S as going toward the inner part of the upper surface 7 (first surface 7).

The first imaginary straight line L1 may intersect with the third region 17 as in the embodiment illustrated in FIG. 5. This leads to enhanced chip discharge performance of the insert 1. The enhanced chip discharge performance is also attainable, for example, in a cutting process of hardened steel that is one kind of high hardness materials.

A surface of the hardened steel has high hardness and the interior thereof has relatively lower hardness than the surface. In a case, the upper surface 7 includes the first region 13 being inclined upward, the cutting edge is less likely to be fractured if cutting out the surface of the hardened steel having the relative high hardness. This leads to enhanced durability.

In the embodiment illustrated in FIG. 5, the upper surface 7 includes a third region 17 being inclined upward, and the third region 17 intersects with the first imaginary straight line L1 as described above. Therefore, even if chips flow in a direction along the first region 13 if cutting out the interior of the hardened steel having the relatively low hardness, the chips tend to be curved in the third region 17.

Additionally, if the upper surface 7 includes a second region 15 located between the first region 13 and the third region 17 in the embodiment illustrated in FIG. 5, the chips are more likely to be curved. This is because if the upper surface 7 includes the second region 15 having a smaller inclination than the first region 13 and the third region 17, it is easy to ensure space for curving the chips on the second region 15.

Thus, the insert 1 in the embodiment illustrated in FIG. 5 has the enhanced chip discharge performance even in a cutting process of a member that is one kind of high hardness materials and has uneven hardness, such as hardened steel. Specifically, the insert 1 in the embodiment illustrated in FIG. 5 is less affected by machining conditions, such as materials of workpieces, and the insert 1 is therefore highly versatile for the workpieces.

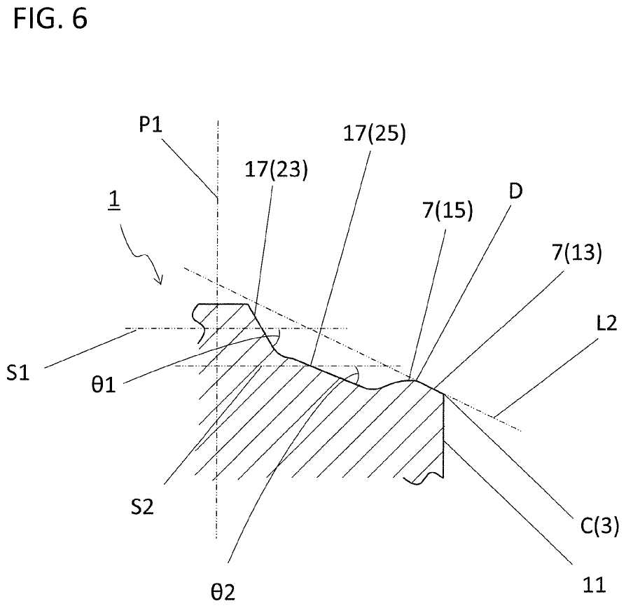

The third region 17 may be located away from a second imaginary straight line L2 as in one embodiment illustrated in FIG. 6. A boundary between the lateral surface 11 and the first region 13 at a position on a bisector M of the first corner 3 in a plan view of the upper surface 7 is a third point C. A boundary between the second region 15 and the first region 13 at a position on the bisector M of the first corner 3 in the plan view of the upper surface 7 is a fourth point D. An imaginary straight line passing through the third point C and the fourth point D is the second imaginary straight line L2.

With the insert 1 including the above configuration, the third region 17 is not too close to the cutting edge, and the chips are therefore not forcibly bent, thereby facilitating to form a good chip shape. Consequently, the chips are stably discharged, and chip clogging is less likely to occur.

In cases where the first corner 3 has the convex curvilinear shape, an imaginary straight line which passes through a center of the first corner 3 and which is orthogonal to the first corner 3 at the center of the first corner 3 in the plan view of the upper surface 7 may be regarded as the bisector M of the first corner 3.

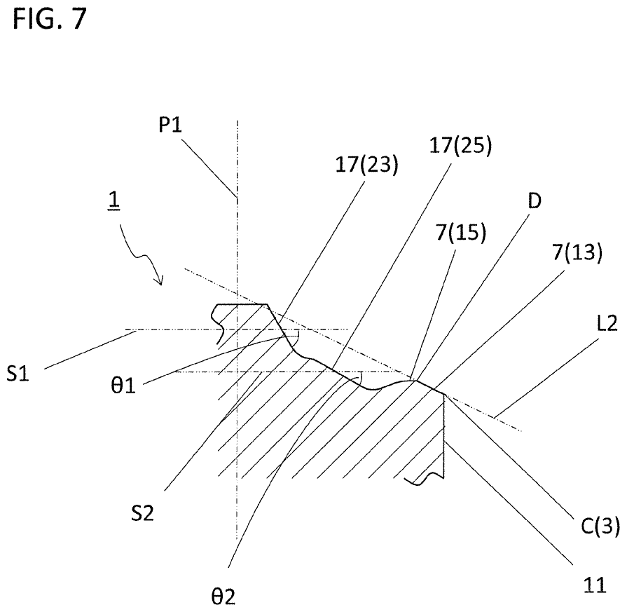

The third region 17 may intersect with the second imaginary straight line L2 as in one embodiment illustrated in FIG. 7. If the insert 1 includes the above configuration, chips tend to come into contact with the third region 17 not only at a position on an orthogonal line of the first side 5 in a plan view, but also at a position on the bisector of the first corner 3 in the plan view. This facilitates to stabilize behavior of chips. FIG. 7 is a diagram illustrating a non-limiting aspect in the present disclosure. FIG. 7 is a cross-section corresponding to FIG. 6.

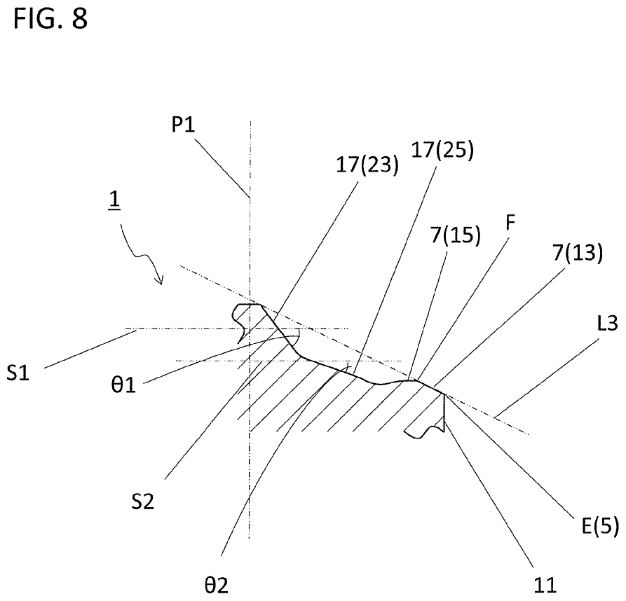

Alternatively, the third region 17 may be located away from a third imaginary straight line L3 as in one embodiment illustrated in FIG. 8. Here, it is assumed that a point on the first side 5 which is located further away from the first corner 3 than the first point A is a fifth point E. The first side 5 may include the fifth point E. FIG. 8 illustrates a cross section that passes through the fifth point E and is orthogonal to the first side 5 in a plan view. A boundary between the first region 13 and the second region 15 is a sixth point F as illustrated in FIG. 8. Similarly to the FIG. 5, the boundary between the first region 13 and the second region 15 is indicated by a point in a sectional view as illustrated in FIG. 8. An imaginary straight line passing through the fifth point E and the sixth point F is the third imaginary straight line L3.

With the insert 1 including the above configuration, the third region 17 is not too close to the cutting edge, and the chips are therefore not forcibly bent, thereby facilitating to form a good chip shape. Consequently, the chips are stably discharged, and chip clogging is less likely to occur.

Still alternatively, the third region 17 may include a first inclined surface 23 and a second inclined surface 25 as in the embodiment illustrated in FIG. 4. The second inclined surface 25 may be located closer to the second region 15 than the first inclined surface 23. Specifically, the second inclined surface 25 may be located between the first inclined surface 23 and the second region 15.

As illustrated in FIGS. 5 to 9, an inclination angle of the first inclined surface 23 relative to the reference plane S parallel to the lower surface 5 is a first angle θ1. An inclination angle of the second inclined surface 25 relative to the reference plane S is a second angle θ2. The first angle θ1 may be larger than the second angle θ2. Specifically, as illustrated in FIGS. 5 to 9, the third region 17 may include a portion where the first angle θ1 is larger than the second angle θ2 in a cross section that includes an orthogonal line of the first side and is orthogonal to the reference plane.

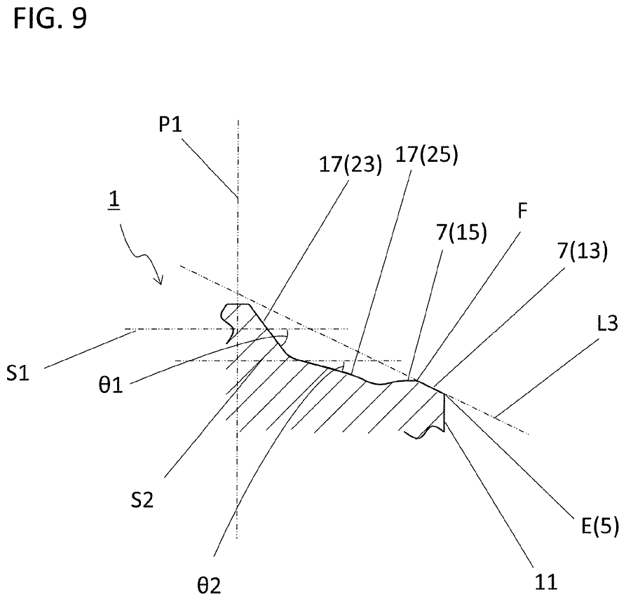

In order to facilitate visual understanding in FIGS. 5 to 9, an imaginary flat surface S1 that is parallel to the reference plane S and intersects with the first inclined surface is illustrated, and the first angle θ1 is indicated by an inclination angle of the first inclined surface 23 relative to the imaginary flat surface S1. An imaginary flat surface S2 that is parallel to the reference plane S and intersects with the second inclined surface 25 is illustrated, and the second angle θ2 is indicated by an inclination angle of the second inclined surface 25 relative to the imaginary flat surface S2. FIG. 9 is a diagram illustrating other non-limiting aspect in the present disclosure. FIG. 9 is a cross-section corresponding to FIG. 8.

In cases where the second inclined surface 25 is located closer to the second region 15 than the first inclined surface 23, the second inclined surface 25 is located closer to the cutting edge than the first inclined surface 23. If the second angle θ2 on the second inclined surface 25 located closer to the cutting edge than the first inclined surface 23 is smaller than the first angle θ1, chips generated by the cutting edge are likely to be curved gradually instead of being rapidly curved when the chips flow to the third region 17. That is, the chips are less likely to be forcibly bent at a position in the vicinity of the cutting edge, thereby facilitating to form a good chip shape. Consequently, chip clogging is less likely to occur.

If the first angle θ1 on the first inclined surface 23 located further away from the cutting edge than the second inclined surface 25 is larger than the second angle θ2, there is a small distance between the first inclined surface 23 and the cutting edge. The chips are therefore likely to come into contact with the first inclined surface 23, thus leading to stable behavior of the chips.

Because of the above configuration, if the first angle θ1 is larger than the second angle θ2, the insert 1 has further enhanced chip discharge performance.

Alternatively, the first side 5 may include a first portion 19 and a second portion 21 as in the embodiment illustrated in FIG. 4. The first portion 19 may connect to the first corner 3. The second portion 21 may be located further away from the first corner 3 than the first portion 19.

An orthogonal line of the first portion 19 in a plan view is a first orthogonal line. An orthogonal line of the second portion 21 in the plan view is a second orthogonal line. A distance from the first portion 19 to an upper end of the third region 17 on the first orthogonal line is a first distance. A distance from the second portion 21 to an upper end of the third region 17 on the second orthogonal line is a second distance. The term “the upper end of the third region 17” denotes a portion of the third region 17 which is located most away from the lower surface 9 in a target range.

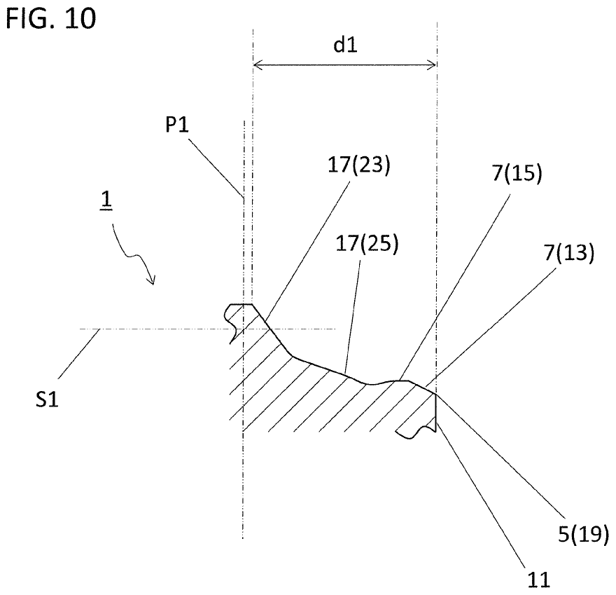

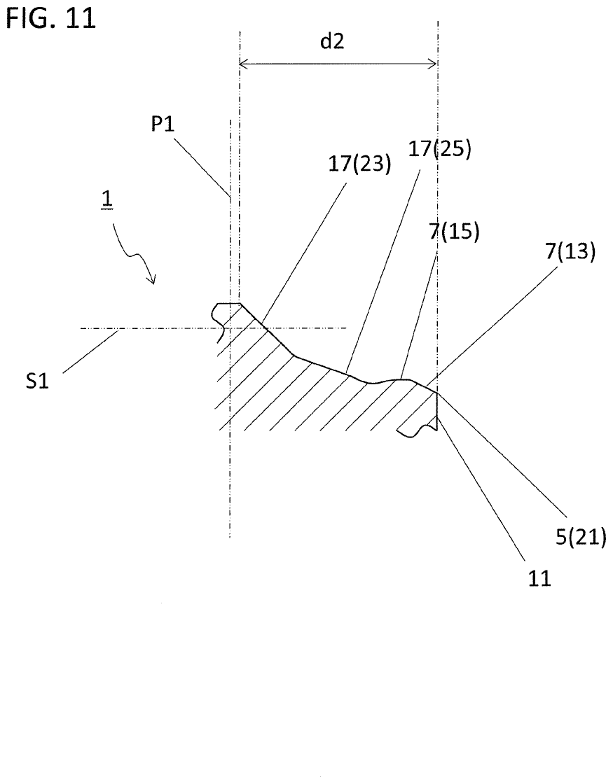

The second distance d2 may be larger than the first distance d1. The first distance d1 in a cross section that includes the first orthogonal line and is orthogonal to the reference plane S is illustrated in one embodiment illustrated in FIG. 10. The second distance d2 in a cross section that includes the second orthogonal line and is orthogonal to the reference plane S is illustrated in one embodiment illustrated in FIG. 11.

With the insert 1 including the above configuration, it is easy to ensure space for discharging chips if the chips flow from the center of the first corner 3 in a direction along the first side 5. This leads to further enhanced chip discharge performance of the insert 1.

The insert 1 may include a hole 31 that opens into an upper end surface 27 as in the embodiment illustrated in FIG. 1. The hole 31 may be extended through a lower end surface 29. The hole 31 is not limited to the above embodiment. For example, the hole 31 may open into the lateral surface of the insert 1. Alternatively, the hole 31 may be extended from one of surface regions constituting the lateral surface of the insert 1 to other surface region located on a side opposite to the former surface region. A central axis P2 of the hole 31 is indicated by two-dot-chain line in FIG. 1. The central axis P2 of the hole 31 may be parallel to the central axis Pl of the cutting part 1b as in the embodiment illustrated in FIG. 1.

The hole 31 is usable as an insertion hole of a fixture for attaching the insert 1 to the holder. Examples of the fixture include a screw, a clamping member and a wedge.

Examples of material of the cutting part 1b include cubic boron nitride (cBN) and diamond. Examples of diamond include PCD (polycrystal diamond). The cutting part 1b may include only one of these materials, or alternatively may include both. If the cutting part 1b may include these materials as a main component, the cutting part 1b may include a material other than these materials. The term “main component” denotes one whose content ratio is the largest in terms of mass ratio.

Examples of material of the base 1a include cemented carbide, cermet and ceramics. However, the material of the base 1a is not limited to these materials.

The insert 1 may include a configuration other than the base 1a and the cutting part 1b. For example, the insert 1 may further include a coating layer to cover a surface of the base 1a and a surface of the cutting part 1b. The coating layer may cover the whole or a part of a base body formed by the base 1a and the cutting part 1b.

Examples of material of the coating layer include aluminum oxide (alumina), and carbides, nitrides, oxides, carbon oxides, nitrogen oxides, carbonitrides and carboxynitrides of titanium. The coating layer may include only one or a plurality of the above-mentioned materials.

The coating layer may be formed by only one layer, or alternatively may be a structure in which a plurality of layers are laminated one upon another. The material of the coating layer is not limited to these materials. The coating layer may be located on the base body by using chemical vapor deposition (CVD) method or physical vapor deposition (PVD) method.

### Cutting Tools

A cutting tool 101 in embodiments is described below with reference to the drawings.

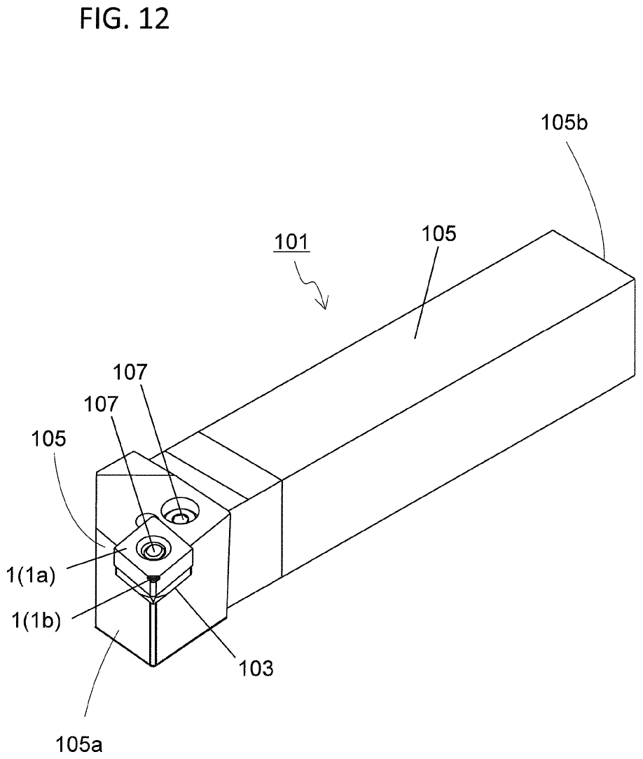

As illustrated in FIG. 12, the cutting tool 101 of the embodiments may include a holder 105 extended from a first end 105a toward a second end 105b. The holder 105 may include a pocket 103 (insert pocket) at a side of the first end 105a. The cutting tool 101 may include the insert 1 located in the pocket 103. The first corner and at least a part of the first side which is used as a cutting edge may be protruded from the first end 105a of the holder 105.

The holder 105 may have a bar shape that is narrow and long. The pocket 103 may be disposed at a side of the first end 105a of the holder 105. The pocket 103 is a part that permits attachment of the insert 1. The pocket 103 may open into an end surface at a side of the first end 105a in the holder 105. If the pocket 103 also opens into a lateral surface of the holder 105, it is easy to attach the insert 1. The pocket 103 may include a seating surface and a constraining lateral surface in one embodiment illustrated in FIG. 12. The seating surface may be a surface approximately parallel to a lower surface of the holder 105. The constraining lateral surface may be a surface inclined relative to the seating surface.

The insert 1 may be located in the pocket 103. For example, a lower end surface of the insert 1 may be in direct contact with the pocket 103. Alternatively, a sheet may be interposed between the insert 1 and the pocket 103.

The insert 1 may be attached to the holder 105 by a clamping member 107 as in the embodiment illustrated in FIG. 12. The insert 1 may be constrained by the pocket 103 by causing a head of the clamping member 107 to be pressed against an inner wall of the hole of the insert 1.

For example, steel or cast iron may be used as a material of the holder 105. Of these materials, the use of steel contributes to enhancing toughness of the holder 105.

The cutting tool for use in a so-called turning process is illustrated in the embodiments. Examples of the turning process include inner diameter processing, outer diameter processing, end surface processing and grooving process. The cutting tool is not limited to one used for the turning process. For example, the insert 1 of the above embodiments may be applied to a cutting tool used for a milling process.

### Method for Manufacturing Machined Product

A method for manufacturing a machined product in embodiments is described below with reference to the drawings.

The machined product is manufacturable by carrying out a cutting process of a workpiece 201. The method for manufacturing the machined product in the embodiments includes the following steps:
(1) rotating the workpiece 201;
(2) bringing at least a part of the first corner and the first side in the cutting tool 101 represented by the above embodiments which is used as a cutting edge, into contact with the workpiece 201 being rotated; and
(3) moving the cutting tool 101 away from the workpiece 201.

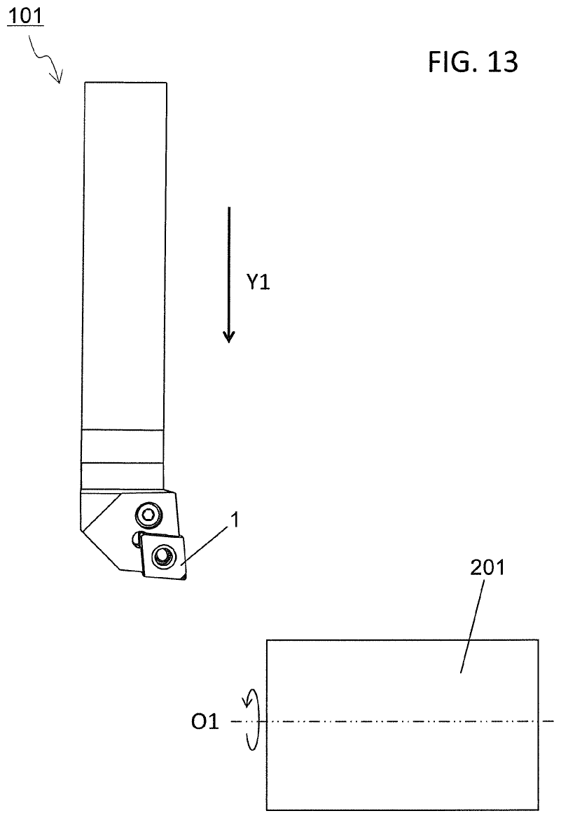

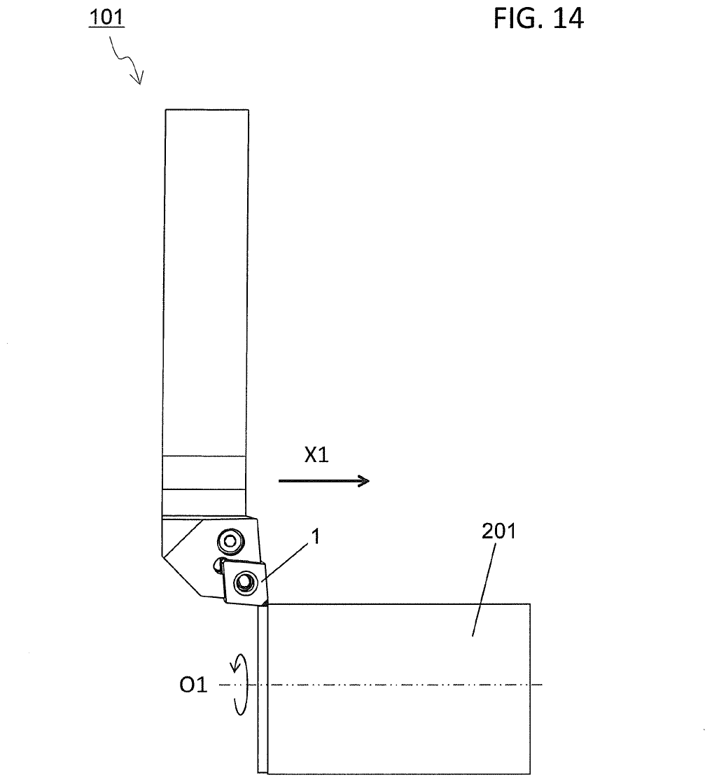

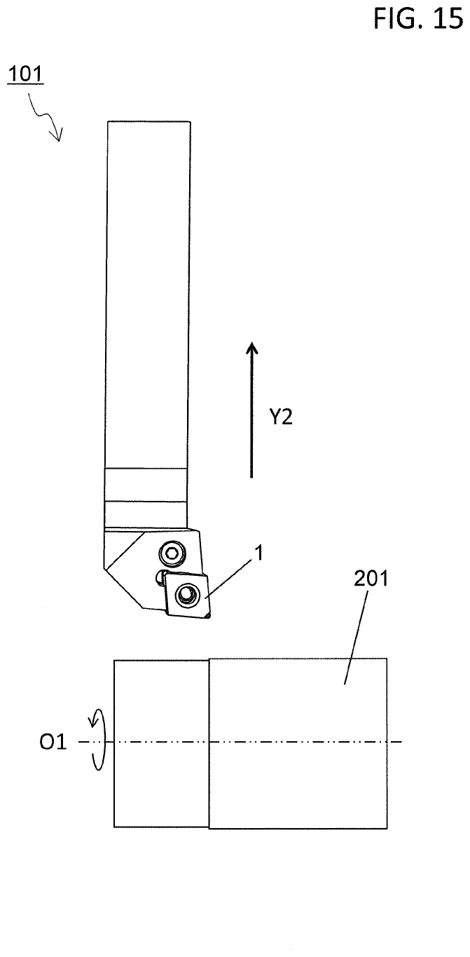

More specifically, firstly, the cutting tool 101 is relatively brought near the workpiece 201 while rotating the workpiece 201 around an axis O1 as illustrated in FIG. 13. The workpiece 201 is then cut out by bringing at least a part of the first corner and the first side in the cutting tool 101 which is used as a cutting edge into contact with the workpiece 201 as illustrated in FIG. 14. Thereafter, the cutting tool 101 is relatively moved away from the workpiece 201 as illustrated in FIG. 15.

The cutting tool 101 may be brought near the workpiece 201 by moving the cutting tool 101 in a Y1 direction in a state where the axis O1 is fixed and the workpiece 201 is rotated. The workpiece 201 may be cut out by bringing at least a part of the first corner and the first side in the insert 1 which is used as a cutting edge, into contact with the workpiece 201 being rotated, and by being moved in an X1 direction. The cutting tool 101 may be moved away from the workpiece 201 by moving the cutting tool 101 in a Y2 direction in a state where the workpiece 201 is rotated.

In the cutting process with the manufacturing method in the embodiments, the cutting tool 101 is brought into contact with the workpiece 201, or the cutting tool 101 is moved away from the workpiece 201 by moving the cutting tool 101 in the individual steps. However, it is not intended to limit to this embodiment.

For example, the workpiece 201 may be brought near the cutting tool 101 in the step (1). Similarly, the workpiece 201 may be moved away from the cutting tool 101 in the step (3). If desired to continue the cutting process, the step of bringing at least a part of the first corner and the first side in the insert 1 which is used as a cutting edge, into contact with different portions of the workpiece 201 may be repeated while keeping the workpiece 201 rotated.

Representative examples of material of the workpiece 201 include hardened steel, carbon steel, alloy steel, stainless steel, cast iron and nonferrous metals.

### DESCRIPTION OF THE REFERENCE NUMERAL

1 cutting insert (insert)
1a base
1b cutting part
3 corner
5 first side
7 first surface (upper surface)
9 second surface (lower surface)
11 third surface (lateral surface)
13 first region
15 second region
17 third region
19 first portion
21 second portion
23 first inclined surface
25 second inclined surface
27 upper end surface
29 lower end surface
31 hole
101 cutting tool
103 pocket
105 holder
107 clamping member
201 workpiece
P1 central axis
P2 central axis
θ1 first angle
θ2 second angle
θ3 third angle
θ4 fourth angle
L1 first imaginary straight line
L2 second imaginary straight line
L3 third imaginary straight line
M bisector
S reference plane
S1 imaginary flat surface
S2 imaginary flat surface

1. A cutting insert, comprising:
a base; and
a cutting part comprising a sintered body of cubic boron nitride or diamond and connecting to the base, wherein
the cutting part comprises
a first surface,
a second surface located on a side opposite to the first surface, and
a third surface located between the first surface and the second surface, the first surface comprises
a corner which has a convex curvilinear shape in a plan view of the first surface,
a first side which has a straight line shape in the plan view of the first surface and extended from the corner,
a first region located along the corner and the first side and inclined upward toward an inner part of the first surface,
a second region which is located along the first region on a more inner part than the first region, and which is inclined relative to the first region, and
a third region which is located at a more inner part than the second region, and which is inclined upward,
a boundary between the corner and the first side is a first point,
a cross section which passes through the first point and is orthogonal to the first side in the plan view of the first surface is a first cross section,
a boundary between the first region and the second region is a second point in the first cross section,
an imaginary straight line passing through the first point and the second point is a first imaginary straight line, and
the first imaginary straight line intersects with the third region in the first cross section.

2. The cutting insert according to claim 1, wherein
a boundary between the third surface and the first region is a third point and a boundary between the second region and the first region is a fourth point at a position on a bisector of the corner in the plan view of the first surface,
a cross section which includes the bisector and is orthogonal to the corner is a second cross section,
an imaginary straight line passing through the third point and the fourth point is a second imaginary straight line, and
the third region is located away from the second imaginary straight line in the second cross section.

3. The cutting insert according to claim 1, wherein
the first side comprises a fifth point located further away from the corner than the first point,
a cross section which passes through the fifth point and is orthogonal to the first side in the plan view is a third cross section,
a boundary between the second region and the first region is a sixth point in the third cross section,
an imaginary straight line passing through the fifth point and the sixth point is a third imaginary straight line, and
the third region is located away from the third imaginary straight line in the third cross section.

4. The cutting insert according to claim 1, wherein
the third region comprises
a first inclined surface, and
a second inclined surface located closer to the second region than the first inclined surface,
an imaginary flat surface parallel to the second surface is a reference plane, and
a first angle that is an inclination angle of the first inclined surface relative to the reference plane is larger than a second angle that is an inclination angle of the second inclined surface relative to the reference plane in the first cross section.

5. The cutting insert according to claim 1, wherein
the third region comprises
a first inclined surface, and
a second inclined surface located closer to the second region than the first inclined surface,
the first side comprises
a first portion connecting to the corner, and
a second portion located further away from the corner than the first portion, in the plan view of the first surface,
an orthogonal line of the first portion is a first orthogonal line, and an orthogonal line of the second portion is a second orthogonal line,
a distance from the first portion to a portion of the third region which is located most away from the second surface on the first orthogonal line is a first distance,
a distance from the second portion to a portion of the third region which is located most away from the second surface on the second orthogonal line is a second distance, and
the second distance is larger than the first distance.

6. A cutting tool, comprising:
a holder extended from a first end toward a second end and comprising a pocket located at a side of the first end; and
the cutting insert according to claim 1, the cutting insert being located in the pocket.

7. A method for manufacturing a machined product, comprising:
rotating a workpiece;
bringing the cutting tool according to claim 6 into contact with the workpiece being rotated; and
moving the cutting tool away from the workpiece.

8. A cutting insert, comprising:
a base; and
a cutting part comprising a sintered body of cubic boron nitride or diamond and connecting to the base, wherein
the cutting part comprises
a first surface,
a second surface located on a side opposite to the first surface, and
a third surface located between the first surface and the second surface, the first surface comprises
a corner which has a convex curvilinear shape in a plan view of the first surface,
a first side which has a straight line shape in the plan view of the first surface and extended from the corner,
a first region located along the corner and the first side and inclined upward toward an inner part of the first surface,
a second region which is located along the first region on a more inner part than the first region, and which is inclined relative to the first region, and
a third region which is located at a more inner part than the second region, and which is inclined upward,
a boundary between the corner and the first side is a first point,
a cross section which passes through the first point and is orthogonal to the first side in the plan view of the first surface is a first cross section,
a boundary between the first region and the second region is a second point in the first cross section,
a boundary between the third surface and the first region at a position on a bisector of the corner in the plan view of the first surface is a third point,
a boundary between the first region and the second region at the position on the bisector in the plan view of the first surface is a fourth point,
a cross section which includes the bisector and is orthogonal to the corner is a second cross section,
an imaginary straight line passing through the first point and the second point is a first imaginary straight line, and an imaginary straight line passing through the third point and the fourth point is a second imaginary straight line, and
the first imaginary straight line intersects with the third region in the first cross section, and the third region is located away from the second imaginary straight line in the second cross section.
